(19) United States
(12) Patent Application Publication
(10) Pub. No.: US 2018/0191734 A1
(43) Pub. Date: Jul. 5, 2018

(54) SYSTEM FOR PROVIDING HEALTH INFORMATION HAVING AUTHENTICATION DATA AND OPERATING METHOD THEREOF

(71) Applicant: ELECTRONICS AND TELECOMMUNICATIONS RESEARCH INSTITUTE, Daejeon (KR)

(72) Inventor: Done Sik YOO, Daejeon (KR)

(21) Appl. No.: 15/449,748

(22) Filed: Mar. 3, 2017

(30) Foreign Application Priority Data
Jan. 5, 2017 (KR) 10-2017-0001978

(51) Int. Cl. H04L 29/06; H04L 9/32; G06F 17/30

(52) U.S. Cl. CPC H04L 63/123; G06F 17/30864; H04L 9/3247

(57) ABSTRACT

Provided are a system for providing health information with authentication data and an operation method thereof. The system for providing health information includes a storage device, a data combination device, and a data authentication device. The storage device may receive health information from at least one external device and store the health information. The data combination device may receive a search condition from a user, extract data corresponding to the search condition from the health information, and generate a data field by combining the data. The data authentication device may generate authentication data including a reference path for original health information from which the data is extracted, and place the authentication data in the data field. The system for providing health information may place authentication data in service health information. Through this, the system for providing health information may improve the reliability for service health information.

### CROSS-REFERENCE TO RELATED APPLICATIONS

This U.S. non-provisional patent application claims priority under 35 U.S.C. § 119 of Korean Patent Application No. 10-2017-0001978, filed on Jan. 5, 2017, the entire contents of which are hereby incorporated by reference.

### BACKGROUND

The present disclosure herein relates to a system for providing health information and an operation method thereof, and more particularly, to a system for providing health information with authentication data and an operation method thereof.

Recently, health information is generated by various devices and institutions. In various hospitals or institutions, medical treatment data about patients may be generated as health information. In addition, health information may be generated in a healthcare application installed in a portable terminal. As health information is generated from various routes, a system for combining and managing the health information is required.

A system for providing health information may combine the health information generated from various routes and provide it to a user. To this end, information desired by the user may be combined by the system for providing health information. In such a case, there are issues of the reliability of the combined health information. More specifically, whether health information is not changed in the combination process may be issues. Therefore, a technique for enhancing the reliability of service health information by the system for providing health information is needed.

### SUMMARY

The present disclosure provides a system for providing health information with authentication data and an operation method thereof.

An embodiment of the inventive concept provides a system for providing health information including a storage device, a data combination device, and a data authentication device. The storage device receives health information from at least one external device and stores the health information. The data combination device receives a search condition from a user, extracts data corresponding to the search condition from the health information, and generates a data field by combining the data. The data authentication device generates authentication data including a reference path for original health information from which the data is extracted, and places the authentication data in the data field.

In an embodiment of the inventive concept, an operation method of a system for providing health information including a storage device to store health information received from at least one external device includes receiving a search condition from a user, extracting data corresponding to the search condition, generating authentication data including a reference path for original health information from which the data is extracted, and generating a data field by combining the extracted data and the authentication data.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a view illustrating an exemplary communication network between a system for providing health information and external devices according to an embodiment of the inventive concept;

FIG. 2 is a block diagram illustrating the system for providing health information shown in FIG. 1 in more detail;

FIG. 3 is a flowchart illustrating a method of providing health information according to an embodiment of the inventive concept;

FIG. 4 is a flowchart illustrating a method of providing health information according to an embodiment of the inventive concept;

FIG. 5 is a block diagram illustrating an exemplary system for providing health information according to an embodiment of the inventive concept; and

FIG. 6 is a view illustrating a system for providing health information according to an embodiment of the inventive concept.

### DETAILED DESCRIPTION

In the following, embodiments of the inventive concept will be described in detail so that those skilled in the art easily carry out the inventive concept.

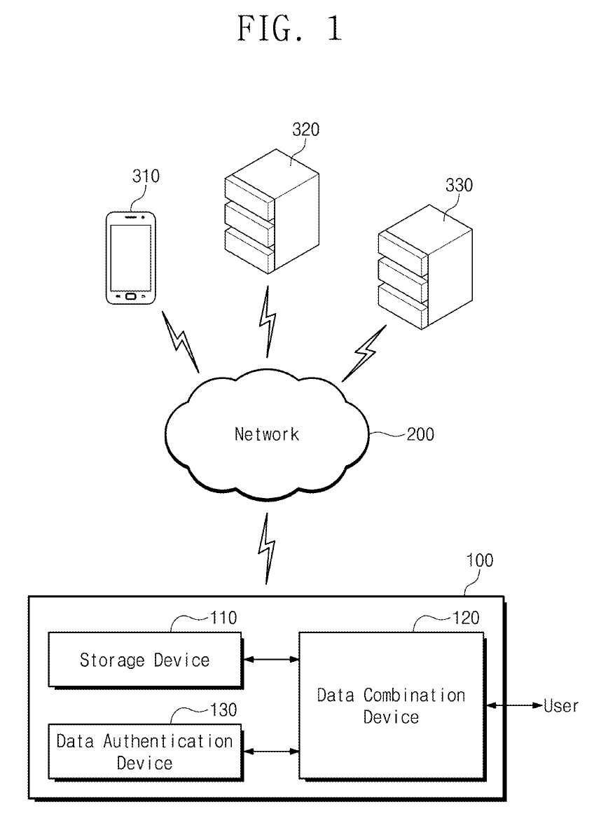

FIG. 1 is a view illustrating an exemplary communication network between a system for providing health information and external devices according to an embodiment of the inventive concept. Referring to FIG. 1, a system for providing health information 100 and external devices 310 to 330 may be connected to each other through a network 200. The system for providing health information 100 receives health information from the external devices 310 to 330 through the network 200 and transmits service health information (i.e., health information desired by a user) to a user based on the received health information.

The network 200 may be implemented in any possible form capable of transmitting data. In an embodiment, the network 200 may be the Internet or a wired/wireless communication network. More specifically, the network 200 may support a health level 7 (HL7), i.e., a standard for electronic exchange of medical information.

The external devices 310 to 330 store health information. For example, the external devices 310 to 330 may be a portable terminal, a server of a medical service provider (e.g., a hospital, a pharmacy, a medical related institution, etc.), and a server of a medical institution (e.g., a health insurance corporation, an insurance company, etc.). However, the external devices 310 to 330 are not limited to the above-described examples, and may refer to all kinds of devices that store health information.

In an embodiment, when the external devices 310 to 330 are portable terminals, the portable terminal may generate health information using a health care application. Alternatively, a user may directly store health information in a portable terminal.

In another embodiment, the external devices 310 to 330 may be a server of a health service provider or a server of a medical related institution. In such a case, the health information may refer to any kind of data generated by a medical service provider. More specifically, health information may include physician's medical care data, clinical trial data, drug experiment data, prescription or medication data for a patient, a hospital admission or discharge history, a patient's insurance history, etc.

The system for providing health information 100 according to an embodiment of the inventive concept may receive health information from various external devices 310 to 330 and provide service health information desired by a user to the user. For example, the service health information may be a personal health record (PHR). Hereinafter, the system for providing health information 100 will be described in detail.

The system for providing health information 100 may include a storage device 110, a data combination device 120, and a data authentication device 130. The storage device 110 may receive health information from the external devices 310 to 330 via the network 200. Health information may be accumulated in the storage device 110 and the system for providing health information 100 may provide service health information to a user using the accumulated health information.

The data combination device 120 may receive a request for service health information from a user. That is, a user may request service health information to the system for providing health information 100. Service health information desired by a user may include various search conditions. More specifically, a user may request various information to the system for providing health information 100, such as exercise information, pulse information, heart rate information, blood glucose information, drug medication information, and the like. The data combination device 120 may extract data corresponding to the received search condition from the storage device 110. The data combination device 120 may generate service health information by combining the extracted data and provide the service health information to a user.

The data authentication device 130 may improve the reliability of service health information provided to a user. The reliability of the service health information may be reduced due to the extraction and combination of the data combination device 120. To prevent this, the data authentication device 130 may generate authentication data. More specifically, the data authentication device 130 may generate a reference path indicating where the data extracted by the data combination device 120 is extracted. Thus, a user can access the original health information through the reference path. Here, the original health information refers to health information generated in the external devices 310 to 330 and stored in the storage device 110.

In another embodiment, the data authentication device 130 may generate signature information in addition to the reference path. The signature information may refer to information indicating that data is not changed due to the extraction and combination of the data combination device 120. More specifically, the signature information may include a hash key, a public key, or an electronic signature key using an encryption scheme. Here, the hash key may mean a unique key value representing the system for providing health information 100.

The data authentication device 130 may provide authentication data (i.e., a reference path or signature information) to the data combination device 120. The provided reference path or signature information may be combined into the service health information along with the data extracted by the data combination device 120.

The system for providing health information 100 according to an embodiment of the inventive concept may provide service health information to a user. For the reliability of the service health information, the system for providing health information 100 may provide a user with the service health information including the reference path or the signature information. The user can confirm that the service health information is the same as the original health information through the signature information, and request the original health information through the reference path. In addition, the user can confirm that the service health information is generated by the system for providing health information 100 through the signature information.

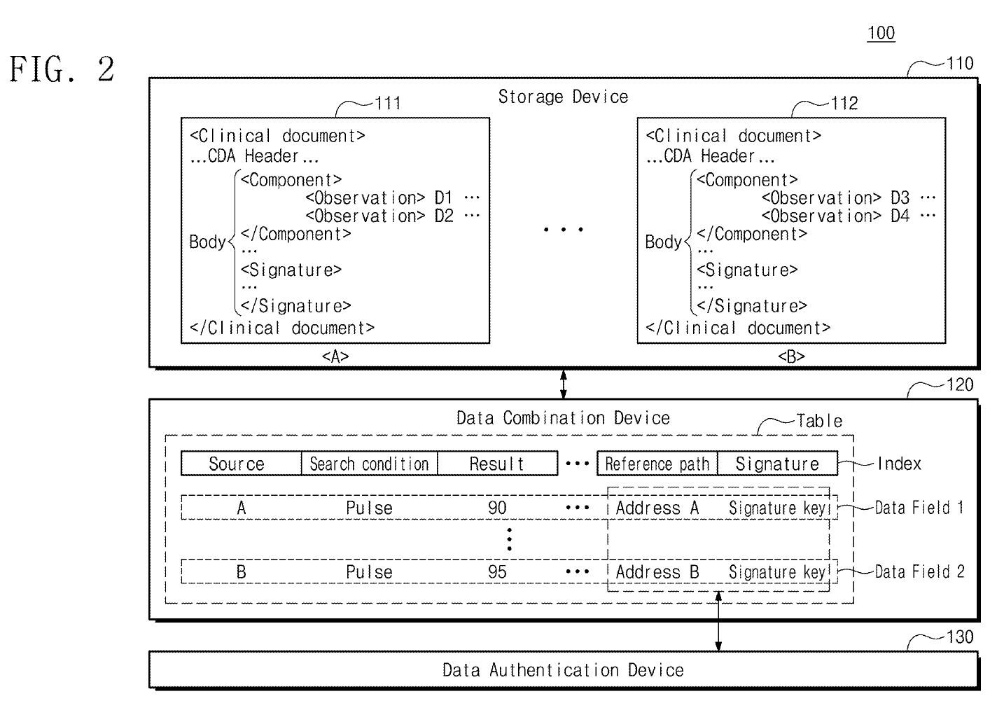

FIG. 2 is a block diagram illustrating the system for providing health information shown in FIG. 1 in more detail. Referring to FIG. 2, the original health information stored in the storage device 110 and the service health information extracted and combined by the data combination device 120 are exemplarily shown.

The storage device 110 may store first original health information 111 received from a hospital A and second original health information 112 received from an institution B. Here, the number, type, and the like of the original health information stored in the storage device 110 are not limited to those shown. In addition, the hospital A and the institution B refer to any hospital or institution.

In an embodiment, the first and second original health information 111 and 112 may be information generated in a clinical document architecture (CDA) document format belonging to the HL7 standard. The first and second original health information 111 and 112 according to the CDA document format are shown in FIG. 2.

A CDA document may be largely composed of a header and a body. Information for identifying a CDA document may be recorded in the header. For example, the header may include information on a creator, a creation date, a creation place, and so on. The body may record health information such as medical care information. For example, the body may include an observation section, and the observation section may include health information desired by a user. In addition, the body may also include a signature section. The signature section may include a signature key of a hospital or institution that generates a CDA document. The signature key may authenticate that the CDA document is created by the hospital or institution that performs the signature. That is, the signature key may authenticate the first and second original health information 111 and 112.

The data combination device 120 may extract from the storage device 110 the data corresponding to the search condition received from the outside (i.e., a user). The data combination device 120 may place the extracted data in a table. Health information desired by a user may be combined into the table. Thus, a user may receive the table (i.e., service health information) and may perform various health management activities (e.g., providing the table to other hospitals or other institutions, establishing exercise or diet plans, etc.). Hereinafter, the table will be described in detail.

The table may include an index and a data field. The index may include a source, a search condition, a result, a reference path, and a signature. The data field may refer to at least one row including data corresponding to the index described above. In an embodiment, when the search condition is a pulse, the data combination device 120 may arrange the pulse data of the hospital A and the pulse data of the institution B in a first data field and a second data field, respectively. Referring to FIG. 2, the pulse data 90 of the hospital A may be placed in the result column of the first data field, and the pulse data 95 of the institution B may be placed in the result column of the second data field. In addition, the data combination device 120 may place information on the search condition and source information of the pulse data in the data field together with the pulse data.

The data authentication device 130 may place authentication data including a reference path and a signature in a data field. The reference path may indicate where the data placed in the result column is extracted. More specifically, the data authentication device 130 may place the address A of the first original health information 111 stored in the storage device 110 in the reference path column of the first data field. Similarly, the data authentication device 130 may place the address B of the second original health information 112 stored in the storage device 110 in the reference path column of the second data field. Through the authentication of the data authentication device 130, the data combination device 120 may easily refer to the original health information (i.e., the first and second original health information 111 and 112) of the first and second data fields. That is, when receiving an authentication request from a user, the data combination device 120 may provide original health information to the user using the address placed on the reference path.

In an embodiment, the data authentication device 130 may place the signature key in the signature column of the first data field and the signature column of the second data field. The signature key included in the table is different from the signature key included in the first and second original health information 111 and 112. That is, the signature key included in the table may mean a unique key value that the system for providing health information 100 has. The signature key included in the table may indicate that the data combination operation is performed by the system for providing health information 100. In another embodiment, the data authentication device 130 may not place signature keys in the first and second data fields. In this case, the reference path may replace the signature key.

In another embodiment, the data combination device 120 may provide the table to a user as service health information. In this case, the table may be generated in a CDA document format. That is, the service health information provided to a user may follow the CDA document format.

In another embodiment, the data authentication device 130 may be included in the data combination device 120 or may be separately implemented as shown in the drawing.

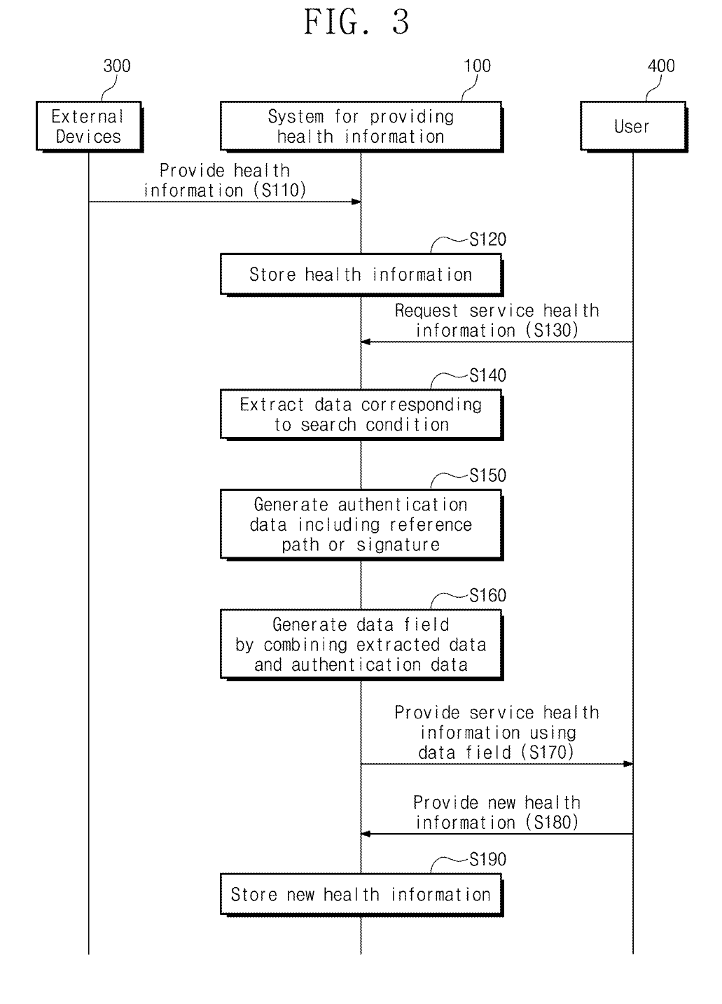

FIG. 3 is a flowchart illustrating a method of providing health information according to an embodiment of the inventive concept. Referring to FIG. 3, operations between a system for providing health information 100, external devices 300, and a user 400 are illustrated. FIG. 3 will be described with reference to FIGS. 1 and 2.

In operation S110, the external devices 300 may provide health information to the system for providing health information 100. Here, the number of the external devices 300 may be at least one. Specific examples of health information are described above with reference to FIG. 1.

In operation S120, the system for providing health information 100 may store the health information received from at least one external device. More specifically, the health information may be stored in the storage device 110 shown in FIGS. 1 and 2.

In operation S130, the user 400 may request service health information from the system for providing health information 100. More specifically, the system for providing health information 100 may receive a search condition from a user.

In operation S140, the system for providing health information 100 may extract data corresponding to the received search condition. As described above with reference to FIG. 2, the extracted data may be placed in a table.

In operation S150, the system for providing health information 100 may generate authentication data including a reference path or a signature. As described above, the reference path may include an address for the original health information from which the data is extracted. The signature may include a unique key value that the system for providing health information 100 has.

In operation S160, the system for providing health information 100 may generate the data field by combining the extracted data and the authentication data. A specific embodiment of the data field is described above with reference to FIG. 2.

In operation S170, the system for providing health information 100 may provide the service health information to a user using the data field. Referring to FIG. 2, the table may include a plurality of data fields. More specifically, the system for providing health information 100 may provide the table to a user.

Operations S180 and S190 correspond to optional operations. That is, operations S180 and S190 may not be performed. In operation S180, if the user 400 is a hospital, the user 400 may generate new health information (i.e., new health data) using the service health information and provide the new health information to the system for providing health information 100. In operation S190, the system for providing health information 100 may store the new health information. Thereafter, the system for providing health information 100 may perform operations S130 through S170 using the stored new health information.

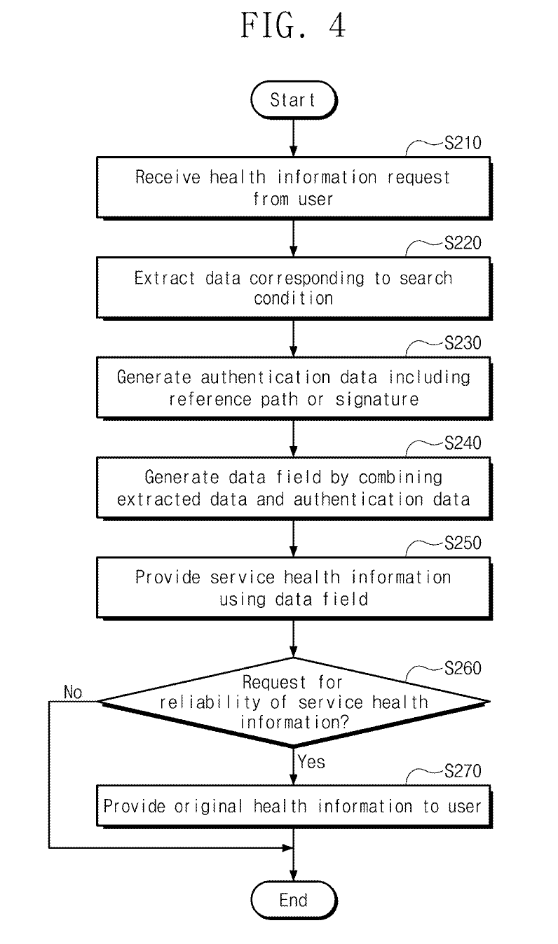

FIG. 4 is a flowchart illustrating a method of providing health information according to an embodiment of the inventive concept. FIG. 4 will be described with reference to FIG. 3.

Through operations S210 to S250, the system for providing health information may provide service health information desired by a user to the user. At this time, for the reliability of the service health information, the system for providing health information may place authentication data in the service health information. Since operation S210 to operation S250 are similar to operation S130 to operation S170 of FIG. 3, their detailed descriptions are omitted.

In operation S260, the system for providing health information may determine whether there is a request for reliability of the service health information. If there is a request for reliability of the service health information (yes), operation S270 is performed, and if not (no), the operation of providing the health information is terminated.

In operation S270, the system for providing health information may provide original health information to a user. At this time, the system for providing health information may provide original health information to a user using the authentication data (more specifically, the reference path) described above with reference to FIG. 2.

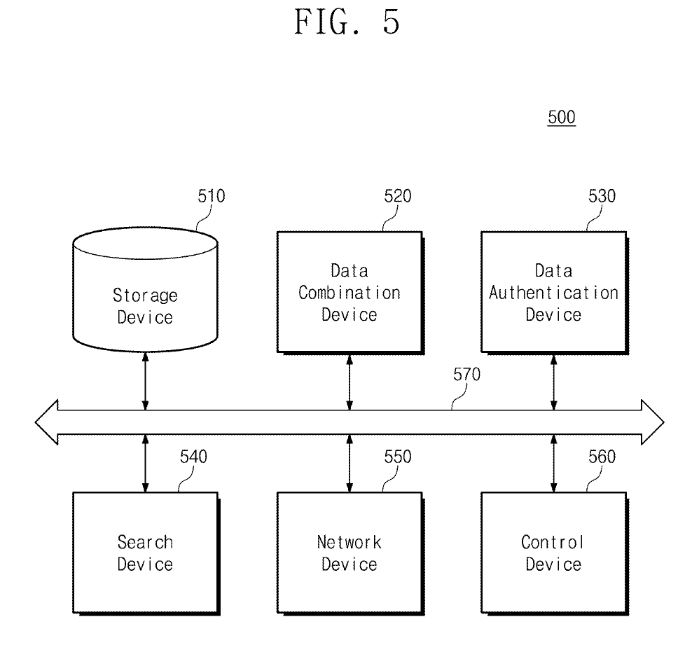

FIG. 5 is a block diagram illustrating an exemplary system for providing health information according to an embodiment of the inventive concept. Referring to FIG. 5, a system for providing health information 500 includes a storage device 510, a data combination device 520, a data authentication device 530, a search device 540, a network device, 550, a control device 560, and a system bus 570. Here, the storage device 510, the data combination device 520, and the data authentication device 530 are substantially similar to those described with reference to FIG. 1 and FIG. 2.

The search device 540 may search for data corresponding to search conditions and provide it to the data combination device 520. In an embodiment, the search device 540 may be included in the data combination device 520. In another embodiment, the search device 540 and the data authentication device 530 may also be included in the data combination device 520.

The network device 550 may support wireless communication such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless LAN (WLAN), ultra wide band (UWB), Bluetooth, wireless display (WI-DI), and the like. In an embodiment, the network device 550 may support wired communication.

The control device 560 may control the storage device 510, the data combination device 520, the data authentication device 530, the search device 540, and the network device 550 in the system for providing health information 500. For example, the control device 560 may be a central processing unit (CPU), a graphics processing unit (GPU), a system on chip (SoC), or an application processor (AP).

The system bus 570 may electrically connect the storage device 510, the data combination device 520, the data authentication device 530, the search device 540, the network device 550, and the control device 560.

In an embodiment, the storage device 510, the data combination device 520, the data authentication device 530, the search device 540, the network device 550 and the control device 560 are implemented separately as shown in the drawing but may be integrated into one. In this case, the system for providing health information 500 may be implemented by a field programmable gate array (FPGA) or an application specific integrated circuit (ASIC).

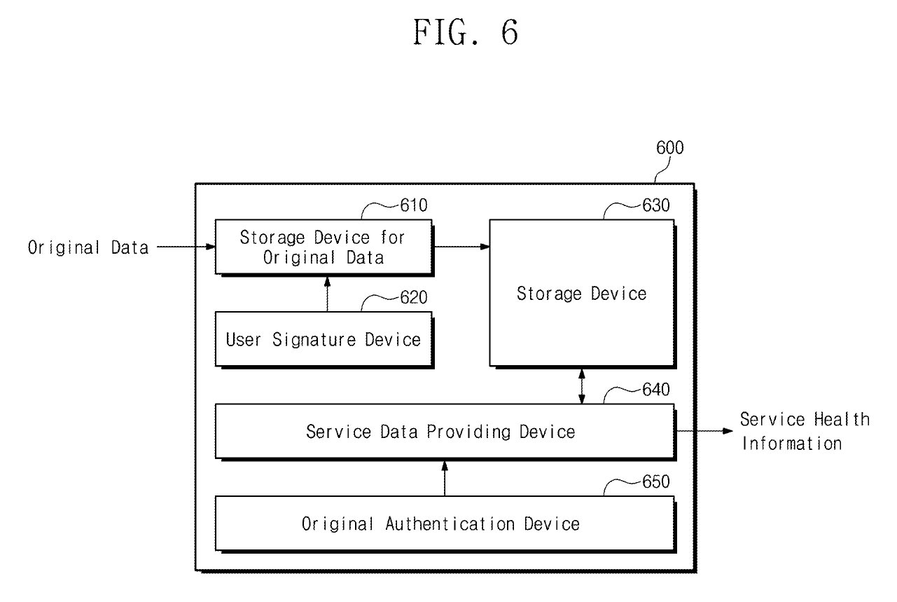

FIG. 6 is a view illustrating a system for providing health information according to an embodiment of the inventive concept. Referring to FIG. 6, a health information system 600 includes an storage device for original data 610, a user signature device 620, a storage device 630, a service data providing device 640, and an original authentication device 650.

The storage device for original data 610 may receive original data from the outside of the health information system 600 (e.g., portable terminal, hospital, pharmacy, medical institution, health insurance corporation, insurance company, etc.). Here, the original data may mean the health information described with reference to FIG. 1.

The user signature device 620 may generate a user signature if there is no signature in the original data stored in the original storage device 610. For example, when a user receives medical treatment at an arbitrary hospital, the hospital may generate medical data (i.e., original data) for the user. The hospital may then sign the medical data using the hospital's electronic signature key for reliability. At this time, the medical data may include the signature of the hospital but not the signature of the user. Accordingly, the user signature device 620 may perform signature on the medical data using the previously stored digital signature keys of users using the system for providing health information 600. In an embodiment, if the original data is already signed by a user, the user signature device 620 may not perform the user's signature on the original data.

The storage device 630 may store the original data as it is (if the original data already includes the user's signature) or store the original data on which the signature of the user is performed. The storage device 630 may perform the same function as the storage device 110 of FIG. 1.

The service data providing device 640 may request and receive service data (i.e., service health information) from other institutions that require data on users using the system for providing health information 600 (e.g., when a user is treated at a new hospital and an insurance company needs a medical record for a user) or devices (e.g., a user's new electronic device). The service data providing device 640 may extract data corresponding to the search condition included in the received service data request, from the storage device 630. The service data providing device 640 may combine the extracted data and output service data by combining the combined data and the authentication data received from the original authentication device 650. The service data providing device 640 may perform the same function as the data combination device 120 of FIG. 1.

The original authentication device 650 may provide the authentication data to the service data providing device 640 for the reliability of the service data. The original authentication device 650 may perform the same function as the data authentication device 130 of FIG. 1. That is, the authentication data may include a reference path for the original data and the signature information of the health information system 600.

A system for providing health information according to an embodiment of the inventive concept may place the authentication data in the service health information. Through this, the system for providing health information may improve the reliability of the service health information.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A system for providing health information comprising:
a storage device configured to receive health information from at least one external device and store the health information;
a data combination device configured to receive a search condition from a user, extract data corresponding to the search condition from the health information, and generate a data field by combining the data; and
a data authentication device configured to generate authentication data including a reference path for original health information from which the data is extracted, and place the authentication data in the data field.

2. The system for providing health information of claim 1, wherein the authentication data comprises signature information on the data field.

3. The system for providing health information of claim 2, wherein the signature information comprises a hash key.

4. The system for providing health information of claim 2, wherein the data combination device generates service health information corresponding to the search condition using the data field and provides the service health information.

5. The system for providing health information of claim 4, wherein the service health information is generated in a clinical document architecture (CDA) document format.

6. The system for providing health information of claim 4, wherein when an authentication request is received from a user, the system for providing health information provides the original health information using the authentication data.

7. The system for providing health information of claim 1, wherein the health information comprises medical data of a hospital or an institution, medical data of a portable device, or medical data of another system for providing health information.

8. An operation method of a system for providing health information including a storage device to store health information received from at least one external device, the method comprising:
receiving a search condition from a user;
extracting data corresponding to the search condition;
generating authentication data including a reference path for original health information from which the data is extracted; and
generating a data field by combining the extracted data and the authentication data.

9. The method of claim 8, wherein the authentication data comprises signature information on the data field.

10. The method of claim 9, further comprising providing service health information corresponding to the search condition using the data field.

11. The method of claim 10, wherein the service health information is generated in a clinical document architecture (CDA) document format.

12. The method of claim 10, further comprising receiving an authentication request from a user and providing the original health information using the authentication data.
